(19) United States
(12) Patent Application Publication
(10) Pub. No.: US 2026/0187168 A1
(43) Pub. Date: Jul. 2, 2026

(54) AUTOMATIC ADVANCE-OF-TRAVEL LOCALIZED RECOMMENDATIONS

(71) Applicant: American Express Travel Related Services Company, Inc., New York, NY (US)

(72) Inventors: Rajendra Prasad MODADUGU, Weston, FL (US); Jyothsna NAYAK, Weston, FL (US)

(73) Assignee: American Express Travel Related Services Company, Inc., New York, NY (US)

(21) Appl. No.: 19/007,114

(22) Filed: Dec. 31, 2024

(51) Int. Cl. G06F 16/9535; G06Q 30/0601; G06Q 50/14

(52) U.S. Cl. CPC G06F 16/9535; G06Q 30/0631; G06Q 50/14

(57) ABSTRACT

System, method, and computer program product embodiments automatically generate localized travel recommendations including in advance of scheduled travel. Transaction data indicative of a purchase is received and used to identify travel booking transaction data indicative of a travel booking purchased using a travel merchant system. Travel booking data associated with the travel booking transaction data is fetched from the travel merchant system. The travel booking data identifies a traveler, a travel destination, and a date and time of travel. A recommendation associated with the at least one travel destination is generated in advance of the date and time of travel based on the travel booking data using a machine-learning model trained on purchase transaction history data. The recommendation, or recommendation content generated based on the recommendation, is presented to a user device of the traveler.

### BACKGROUND

### Field

This application generally relates to communications systems, communications protocols, and machine-learning models for acquiring data and providing customized data delivery based on a user's transaction history and other information, and in particular to automatic advance-of-travel localized recommendations.

### Related Art

Informational messages sent to a user device that are customized for a user's location are sometimes based on real-time location data provided by a user device, for example, based on Global Positioning System (GPS) data or cellular or internet communication data (e.g., internet protocol address data) from which a present location can be estimated.

### BRIEF SUMMARY

Disclosed herein are system, apparatus, device, method and/or computer program product embodiments, and/or combinations and sub-combinations thereof, for automatically generating and delivering, to an electronic device of a traveler, recommendation information related to the traveler's destination of travel prior to and during the travel.

Computer-implemented methods, systems, and non-transitory computer-readable devices as described herein can query a data source, such as a system of a travel merchant from whom a travel booking is purchased, to retrieve travel booking data, based on transaction data received as a result of a purchase transaction, or can receive such travel booking data from the data source, including directly from a user. The travel booking data includes one or more dates and times of travel, one or more travel destinations, and information identifying one or more travelers. Recommendation information is generated based on the detailed travel booking data and profile data associated with the travelers, for example, using one or more machine-learning models trained to generate the recommendation information. A consent process can provide traveler consent before the travel booking data is retrieved and recommendation information is generated and delivered.

System, method, and computer program product embodiments automatically generate localized travel recommendations including in advance of scheduled travel. Transaction data indicative of a purchase is received and used to identify travel booking transaction data indicative of a travel booking purchased using a travel merchant system. Travel booking data associated with the travel booking transaction data is fetched from the travel merchant system. The travel booking data identifies a traveler, a travel destination, and a date and time of travel. A recommendation associated with the at least one travel destination is generated in advance of the date and time of travel based on the travel booking data using a machine-learning model trained on purchase transaction history data. The recommendation, or recommendation content generated based on the recommendation, is presented to a user device of the traveler.

### BRIEF DESCRIPTION OF THE DRAWINGS

The accompanying drawings are incorporated herein and form a part of the specification.

FIG. 1 is a block diagram of an automatic advance-of-travel localized recommendation environment, according to some embodiments.

FIG. 2 is a block diagram showing example functioning of elements of the automatic advance-of-travel localized recommendation environment of FIG. 1 to identify customer travel transactions.

FIG. 3 is a block diagram showing example business-to-business access management for fetching detailed travel booking data.

FIG. 4 is a block diagram showing example user-to-business access management for detailed travel booking data.

FIG. 5 is a block diagram showing example functioning of elements of the automatic advance-of-travel localized recommendation environment of FIG. 1 to train a machine-learning model to identify user preferences.

FIG. 6 is a sequence diagram illustrating an example sequence for engaging a user and providing local recommendation information to the user.

FIG. 7 is a flow diagram illustrating an example computer-implemented method of advance-of-travel localized recommendations.

FIG. 8 is a block diagram illustrating an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for a system for providing advance-of-travel localized recommendation information. An example result of the features described herein is that a user who purchases a travel booking (e.g., airfare, a train ticket, long-distance bus fare), or other traveler(s) associated with the travel booking, can receive, with precise delivery timing (e.g., prior to or coincident with arrival at the travel destination), recommendation information related to the travel. The recommendation information can include, for example, noncommercial information, commercial advertisements, offers, promotions, or coupons regarding places of interest or merchants in the vicinity of the travel destination, customized for the dates and times of the user's travel.

The purchase of the travel booking may create transaction information available to a bank, credit union, or other financial services organization providing the financial account (e.g., credit card account, debit card account, cryptocurrency account, or electronic funds transfer account) used to purchase the travel booking. This transaction information may, however, generally include only such information as the merchant name and/or other merchant identifier, the purchaser's name and/or purchaser's account identifier, the general category of the purchase, the purchase amount (purchase price), and other such information essential for completing payment processing, and may not include information about the identity or identities of the persons or persons traveling, the travel destination(s), and/or the date(s) and/or time(s) of travel.

Because timing can play a crucial role in presenting travel recommendation information, the systems, methods, and computer-readable devices described herein aim to time the presentation of travel recommendation information based on pre-planned travel booking details. For example, a traveler may be more inclined to ignore recommendations that are only presented to the traveler after travel has already commenced, when it may be too late or too inconvenient for the traveler to modify travel plans based on the newly presented recommendations. Accordingly, recommendations made based solely on real-time location information may be of lesser practical value than recommendations made in advance of travel, or timed to coincide with certain travel events, such as the anticipated time of a flight landing. However, a financial services organization with a sophisticated understanding of a user's spending preferences based on extensive transaction history data may not be provided travel booking data, such as information identifying of one or more travelers associated with a travel booking, one or more destinations associated with the travel booking, and one or more travel dates and times associated with the travel booking, as may be needed to make customized recommendations in advance of travel or precisely timed to certain travel events. Technical challenges in providing advance-of-travel recommendation functionality can be addressed by coordinated interactions between different information systems controlled by different entities.

In some embodiments, therefore, the systems, methods, and computer-readable devices described herein may automatically retrieve travel booking data associated with the travel booking purchase, such as one or more names or other identifiers of one or more travelers associated with the travel booking purchase, one or more travel destinations associated with the travel booking purchase, and one or more dates and times of travel associated with the travel booking purchase, from a travel merchant system, e.g., in response to a user authorization that grants consent to such automatic information retrieval. In some embodiments, this travel booking data can be voluntarily provided (e.g., in advance of travel) by a user. In either case, the localized information received by the user can be delivered in advance of travel, and the localized information can be customized based on information about the travel destination and/or the date(s) and/or time(s) of travel that is not available from the transaction information alone.

In some examples, the systems, methods, and computer-readable devices described herein can enable time-specific recommendations (e.g., delivered in advance of a travel event and/or in real-time) based on estimated, predicted, or determined traveler location through a combination of geotargeting and scheduling functionalities. The systems, methods, and computer-readable devices described herein can use geolocation data to determine a traveler's location and time zone, and can tailor recommendations accordingly. The systems, methods, and computer-readable devices described herein can further ensure proper user consent and privacy considerations in implementing such features.

In some examples, the systems, methods, and computer-readable devices described herein can enhance time-specific offers. As one example of enhancing time-specific offers, the systems, methods, and computer-readable devices described herein can analyze user behavior patterns to identify optimal time slots for engagement (e.g., for presentation of recommendations). As another example of enhancing time-specific offers, the systems, methods, and computer-readable devices described herein can personalize recommendations based on historical data, preferences, and purchase history. As yet another example of enhancing time-specific offers, the systems, methods, and computer-readable devices described herein can implement push notifications or in-application messages to alert users about exclusive deals during targeted time frames, creating a more tailored and effective marketing strategy. The systems, methods, and computer-readable devices can thereby reach the right audience at the right time, ensuring that promotions are relevant to local interests and needs.

Furthermore, by directly coupling with a travel merchant system to receive advance-of-travel information pertinent to a user's upcoming or imminent travel for a particular user, as compared to systems or methods that rely only on real-time location data from a user device, the systems, methods, and computer-readable devices described herein can avoid having to retrieve information about irrelevant recommendation items or submit multiple different queries to a recommendation model to locate relevant recommendation items, thereby conserving computing, throughput, and power resources of one or more system servers and/or network components. For example, computing resources (e.g., power, processor cycles, memory, or the like) of one or more system servers executing a localized recommendation system, including recommendation machine-learning model, may be conserved and resources (e.g., bandwidth, switching operations, or the like) of network may be conserved. This is because a travel destination can be better understood in advance and guesses about travel need not be continually made, and recommendations continually revised, based solely on real-time location data (e.g., GPS) data, which may provide very little clue as to an ultimate destination as it is being revised and transmitted.

Various embodiments of these features are discussed with respect to the corresponding figures.

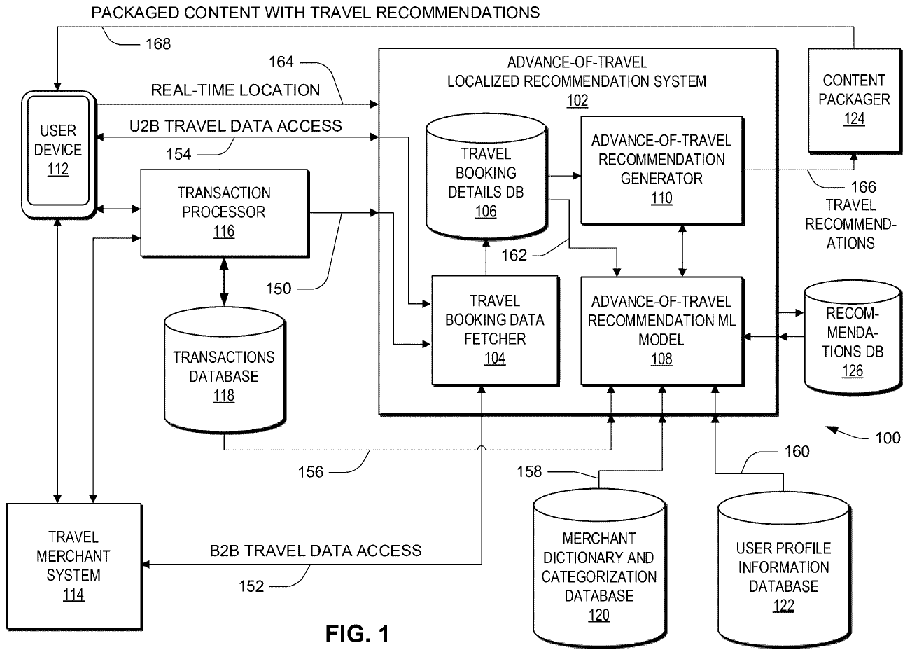

FIG. 1 is a block diagram of an automatic advance-of-travel localized recommendation environment 100, according to some embodiments. Automatic advance-of-travel localized recommendation environment 100 includes an advance-of-travel localized recommendation system 102, which includes a travel booking data fetcher 104, a travel booking details database 106, an advance-of-travel recommendation machine-learning (ML) model 108, and an advance-of-travel recommendation generator 110.

Advance-of-travel localized recommendation system 102 may determine one or more travel recommendations, which can be packaged and presented to a user device 112 of a traveler. As examples, the travel recommendations can be packaged and presented as noncommercial messages, advertisements, and/or electronic coupons.

Advance-of-travel localized recommendation system 102 can be a system in the custody and/or control of a financial services organization, such as a bank, credit union, credit card issuer, cryptocurrency exchange, or electronic money payment processing company. Advance-of-travel localized recommendation system 102 can be implemented, in various examples, as hardware, software, or some combination of hardware and software. In some examples, advance-of-travel localized recommendation system 102 is implemented as a cloud-based software system running on a server or a set of servers. Various elements and/or functions of the advance-of-travel localized recommendation system 102 can be implemented as different services running on a single server or distributed amongst multiple servers. In some examples, advance-of-travel localized recommendation system 102 can be implemented in whole or in part as dedicated hardware circuitry, such as on an application-specific integrated circuit (ASIC) or field-programmable gate array (FPGA). In others examples, the various components of the advance-of-travel localized recommendation system 102 can be executed using one or more general-purpose computer processors.

User device 112 may be a personal computer (e.g., a desktop workstation, a laptop computer, a notebook computer, or a netbook computer), a mobile device (e.g., a smartphone, a tablet device, a personal digital assistant (PDA), a smart watch or other wearable), an appliance, a part of the internet-of-things (IoT), an embedded system, or any other personal computing device capable of communicating with other elements of the environment 100 via a network such as the internet. Different instances of user device 112 can be used at different phases of operation of environment 100. For example, a first user device 112 can be used to purchase a travel booking, and a second user device 112 can receive travel recommendations. As another example, a first user device 112 can be used to purchase a travel booking, a second user device 112 can be used to grant authorization for sharing of travel data between a travel merchant system 114 and the advance-of-travel localized recommendation system 102, and a third user device 112 can receive travel recommendations. As yet another example, a first user device 112 can be used to purchase a travel booking, a second user device 112 can be used to directly share travel data with the advance-of-travel localized recommendation system 102, and a third user device 112 can receive travel recommendations.

In some examples, a user device 112 is involved in a travel booking purchase. For example, a user device 112 can be used to access a website of a travel merchant, or to execute an application provided by the travel merchant, in either case to communicate with a travel merchant system 114. The travel merchant system 114 can be a booking platform in the custody and/or control of a seller of travel bookings. As examples, the travel merchant system 114 can belong to an airline, a long-distance bus line, a cruise or ferry line, a passenger rail line, or an intermediary or reseller such as a travel agency (e.g., an online travel agency) or third-party travel booking seller. The travel merchant system 114 can itself include a variety of systems and subsystems, not illustrated in FIG. 1, to perform its tasks of collecting and listing or otherwise presenting fare options to a user and executing booking purchase transactions. The travel merchant system 114 can also include one or more data storage and/or data provision systems configured to provide travel booking data to authorized external entities, e.g., through application programming interface (API) calls. The authorized external entities are, for example, entities other than an organization in custody or control of the travel merchant system 114, but which may be authorized to access the travel booking data, e.g., through partnership agreements.

The travel merchant system 114 can, for example, be configured to provide listings of travel options (e.g., airplane tickets, train tickets, bus tickets, or boat or ferry tickets), to book travel reservations, and to accept payment for travel bookings, e.g., by credit or debit card, cryptocurrency, or electronic money payment. In such examples, payment account information can either be sent from the user device 112 to the travel merchant system 114 and subsequently on to a transaction processor 116, or, if so configured, directly from the user device 112 to the transaction processor 116 without the payment account information being provided to the travel merchant system 114. In some other examples, a user device 112 is not involved in the travel booking purchase. For example, a credit card or debit card can be used to make the travel booking purchase at a physical location, such as at a travel agency, without a user employing a user device 112 to make the purchase. In such examples, payment account information can be sent from the travel merchant system 114 to the transaction processor 116.

Whether by using a user device 112 or not, a travel booking purchaser's account information can be processed by the transaction processor 116 to execute the payment from the purchaser's account to the travel merchant, with associated transaction data being stored in a transactions database 118. The transaction processor 116 can include or can be coupled to, for example, a credit card and/or debit card payment network. For example, the transaction processor 116 and the transactions database 118 can be in the custody and/or control of a financial services organization, such as a credit card company. The transaction processor 116 may also be configured with fraud detection functionality to decline purchase payments for transactions that are detected as likely fraudulent.

Transactions database 118 can store transactions data associated with transactions from different users. The transactions data stored in the transactions database 118 can include, for example, a purchaser name and/or purchaser identifier (e.g., purchaser account number) associated with a purchase transaction, a merchant (seller) name and/or merchant identifier (e.g., merchant account number) associated with the purchase transaction, a date and/or time associated with the purchase transaction, a price of purchase, and/or a category of purchase associated with the transaction. For example, the transaction processor 116 may understand, based on the merchant associated with the purchase transaction and/or other data associated with the purchase transaction, that the category of purchase may be “travel,” or, more specifically, “airfare.” The transaction processor 116 may understand, based on the merchant associated with the purchase transaction and/or other data associated with the purchase transaction, which airline or other carrier the purchase is associated with.

It may be, however, that the transaction processor 116 is not configured to receive, and/or the transactions database 118 is not configured to retain, travel booking data associated with the purchase transaction, such as the names or other identifying information of one or more travelers associated with the travel booking purchase, one or more dates and times of travel associated with the travel booking purchase, and one or more travel destinations associated with the travel booking purchase. This may be the case, for example, because this more detailed travel booking data is not needed in order to execute the transaction payment process, and the transaction processor 116 and transactions database 118 are configured to execute the transaction payment process and not to receive or retain such additional transaction booking data. It may be, for example, that user data privacy considerations are implicated, preventing transaction processor 116 and transactions database 118 from receiving and/or storing more detailed travel booking data than is necessary to execute the payment for the travel booking. Thus, this detailed travel booking data may remain only with the travel merchant system 114 and/or with one or more user devices 112 of the travel booking purchaser and/or traveler(s) associated with the booking.

The various connections between components in the environment 100 of FIG. 1, such as connections 150, 152, 155, 156, 158, 160, 162, 164, 166, 168, and others that are unlabeled, can be connections over a network (e.g., the internet). These connections can have intervening components and systems and need not be direct connections. In some instances, coupled components or systems can reside on the same server or physical computer device and need not be coupled with network connections, in which case the illustrated connections can represent software connections, whereby one component or system is configured to address memory or computational resources of another component or system.

In some examples, the transaction processor 116 can be configured to push transaction data for new transactions to the advance-of-travel localized recommendation system 102, e.g., to the travel booking data fetcher 104 of the advance-of-travel localized recommendation system 102. In other examples, the advance-of-travel localized recommendation system 102 (e.g., its travel booking data fetcher) can fetch the transaction data from the transactions database 118, e.g., intermittently or periodically, to retrieve transaction data newly added to the transactions database 118 since the last fetch operation. The advance-of-travel localized recommendation system 102 (e.g., its travel booking data fetcher 104) can be configured to recognize (identify) travel booking transaction data indicative of a travel booking purchased using the travel merchant system 114. For example, the advance-of-travel localized recommendation system 102 can determine that a transaction in the received transaction data includes a travel booking purchase based on the identity of the merchant associated with the transaction, as may be found in the received transaction data, a categorization of the merchant (e.g., as an airline or other travel entity), and/or the transaction price. For example, a purchase made from a merchant categorized as an airline exceeding a certain price threshold may be determined to be a likely flight booking purchase and thus identified as a travel booking transaction having travel booking transaction data.

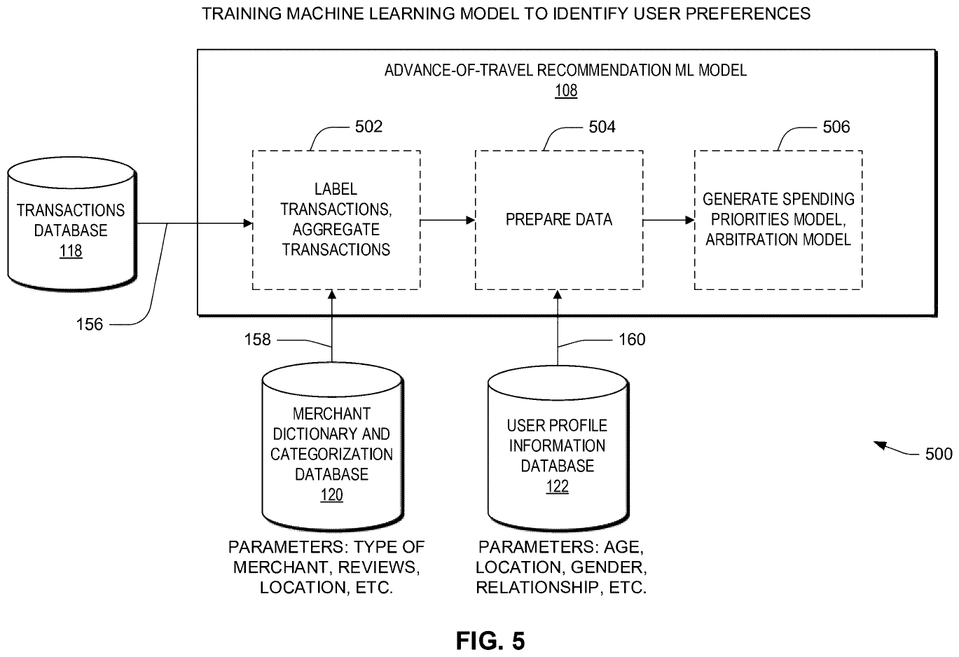

The travel booking data fetcher 104 of the advance-of-travel localized recommendation system 102 can be configured to fetch or receive travel booking data associated with a travel booking purchase transaction, such as names or other information identifying one or more travelers associated with the travel booking, one or more dates and times of travel, and one or more travel destinations, either from the travel merchant system 114 in a business-to-business (B2B) travel data access operation, or directly from a user device 112 in a user-to-business (U2B) travel data access operation. The travel booking data may, in some examples, also include one or more identifiers for specific voyages, such as one or more flight numbers. The travel booking data can be stored in a travel booking details database 106 of the advance-of-travel localized recommendation system 102, and/or can be used to generate travel recommendations. For example, the advance-of-travel recommendation ML model 108, trained on the purchase behaviors and preferences of users, can process the travel details to output raw recommendations associated with merchants located in the destination(s) of travel. In some examples, generated recommendations can be selected and/or ranked from among recommendations stored in a recommendations database 126, which can be automatically or manually curated to include current merchant offers and promotions. As described in greater detail below with regard to FIG. 5, the advance-of-travel recommendation ML model 108 can be trained, for example, using data from a merchant dictionary and categorization database 120 and a user profile information database 122. The raw recommendations can be provided to advance-of-travel recommendation generator 110 of the recommendation system 102, which can generate recommendations such as offers, advertisements, or coupons timed to the travel.

In generating travel recommendations, the advance-of-travel recommendation ML model 108 can consider the account used to purchase the travel booking. For example, if the account used to purchase the travel booking is a business account or is otherwise determined to be used primarily for business purchases, the advance-of-travel recommendation ML model 108 may understand this to likely indicate that the purpose of the travel is business. In generating travel recommendations, the advance-of-travel recommendation ML model 108 can consider the travelers used to purchase the travel booking. For example, if co-travelers are determined to be likely business colleagues rather than friends or family members based on user profile information from user profile information database 122, the advance-of-travel recommendation ML model 108 may understand this to likely indicate that the purpose of the travel is business. In generating travel recommendations, the advance-of-travel recommendation ML model 108 can consider other factors, such as the destination and/or the length of a stay between round-trip travel (travel window). For example, the advance-of-travel recommendation ML model 108 may understand a short trip to a destination that is more frequently a business destination than a pleasure destination (either for a particular user or for users in aggregate) to likely indicate that the purpose of the travel is business. Based on the understanding that the purpose of the trip is likely business and not pleasure, the advance-of-travel recommendation ML model 108 may output business-oriented recommendations (e.g., business hotel accommodations or business dining) rather than, or ranked higher than, pleasure-oriented or tourism-oriented recommendations (e.g., shopping or tourism sights).

As another example, the advance-of-travel recommendation ML model 108 may understand that a business traveler with a longer travel window may be more receptive to pleasure-oriented or tourism-oriented recommendations and may therefore prioritize pleasure-oriented or tourism-oriented recommendations accordingly. The ability to provide or rank recommendations based on travel window is another advantage of advance-of-travel localized recommendation system 102 over systems or methods that may rely solely or primarily on real-time location information to generate recommendations and/or to time the presentations of recommendations to users.

In generating travel recommendations, the advance-of-travel recommendation ML model 108 can consider past transactions made by the traveler based historical transactions data in the transactions database 118 and/or user profile information from the user profile information database 122, the latter of which may include metrics summarizing user preferences and behaviors. For example, the advance-of-travel recommendation ML model 108 may understand that a user prefers economy-budget options rather than more expensive options in certain purchase categories, and may tailor travel recommendations accordingly. As another example, the advance-of-travel recommendation ML model 108 may understand that a user prefers some dining subcategories over other dining subcategories, and may tailor travel recommendations accordingly.

Advance-of-travel recommendation generator 110 can be configured to account for timing of presentation of recommendations, and thereby to generate and/or present recommendations to the user device 112 at times predicted to be those when the corresponding user is likely to be most receptive to the recommendations. As described above, the advance-of-travel localized recommendation system 102 can present recommendations to a user device of a traveler in advance of booked travel, or timed during the booked travel but well enough in advance that the recommendation recipient has enough time to consider the recommendation(s) and incorporate favorably received recommendation(s) into the recipient's travel agenda. Accordingly, although the advance-of-travel localized recommendation system 102 may take into account the real-time location of the user (e.g., using location data reported from a user device 112 via connection 164) when making recommendations, the advance-of-travel localized recommendation system 102 advantageously may also take into account travel information, including date(s) and time(s) of travel, sourced either directly from a traveler via a U2B travel data access process or from a travel merchant system via a B2B travel data access process.

Advance-of-travel recommendation generator 110 can be configured to automatically query the advance-of-travel recommendation ML model 108 to generate or re-generate recommendations or ranked lists of recommendations. For example, advance-of-travel recommendation generator 110 can be configured to query the advance-of-travel recommendation ML model 108 to prompt the model 108 to generate or re-generate travel recommendations at determined appropriate presentation times when recommendations should be presented, or before such determined appropriate presentation times, so that such recommendations may be queued for presentation at the determined appropriate presentation times. As an example, advance of travel recommendation generator 102 can receive travel dates and times from the travel booking details database 106 and can base presentation times on the travel dates and times. Accordingly, the advance-of-travel localized recommendation system 102 need not be reliant only on real-time location reporting (e.g., as reported from a GPS system of a user device 112) but can also be informed of likely user location(s) in advance, and can therefore generate recommendations well enough in advance of a user's presence in a location that the timing of the presentation of the recommendation(s) can be improved.

Having received one or more outputs of advance-of-travel recommendation ML model 108, the advance-of-travel recommendation generator can determine appropriate times for presentation of recommendations and can queue recommendations to be transmitted to the user device 112 at the determined appropriate times. As one example, travel recommendations pertinent to can be timed to be presented the morning of travel, but before the travel has commenced (e.g., before an airplane is scheduled to take off). As another example, recommendations can be timed to be presented the day before travel. In either of these examples, it would not be possible to present the recommendations with such timing based on real-time (e.g., GPS) location data alone.

Content packager 124 can package recommendations generated by the advance-of-travel recommendation generator 110 of the advance-of-travel localized recommendation system 102. The packaging of the recommendations can entail, for example, the incorporation or embedding of recommendation information into appealing content, such as textual, graphical, or textual-graphical, or audio content. As examples, the packaged content can be still-image content, audio content, video content, audio-visual content, or gamified content. In some examples, one or more rule-based systems or templates can be used to generate the packaged content based on the recommendation information. In some examples, the content packager 124 can include one or more generative artificial intelligence (“generative AI”) models to generate the packaged content based on the recommendation information. The packaged content can be presented to the user device 112 via various communication channels, including push notifications, email, social media advertising, mobile application (“app”) notifications, and website banners. For example, content packager 124 may generate visual elements for integration into a graphical user interface (GUI). Accordingly, connection 168 may include one or more intermediaries, such as one or more third-party organizations (e.g., websites, social media networks, or online ad placement services). The visual elements may be updated to include the personalized, localized, timed travel recommendations and be communicated to the user device 112 associated with the traveler.

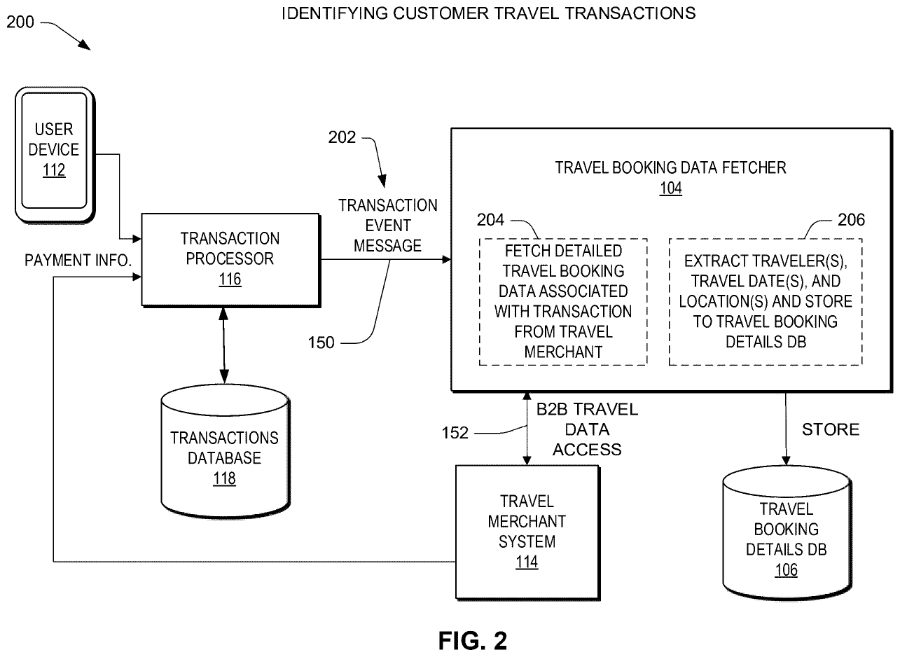

An example process of identifying customer travel transactions and fetching travel booking data is described with reference to FIG. 2, which includes a simplified arrangement 200 of elements of the environment 100 of FIG. 1. As described above, the transaction processor 116 can accept payment information (e.g., a credit card number and associated data, such as account holder name). The transaction processor 116 can accept the payment information, as examples, from a user device 112 or travel merchant system 114 into which a user (fare purchaser) has input the payment information. The transaction processor 116 can store certain information related to the transaction payment processing, but not necessarily the names or other identifying information of the traveler(s), date(s) and time(s) of travel, and travel destination(s), in the transactions database 118. Transactions database 118 may be a data lake, data silo, semi-structured data system (CSV, logs, XML, etc.), unstructured data system, binary data repository, or other suitable repository. The processing of the transaction by the transaction processor 116 can trigger a transaction event message 202 which can be sent from the transaction processor 116 to the advance-of-travel localized recommendation system 102, e.g., to a travel booking data fetcher 104 of the advance-of-travel localized recommendation system 102, via connection 150 (e.g., the internet or an intranet).

The receipt of the transaction event message 202 can prompt the advance-of-travel localized recommendation system 102 to determine whether or not the transaction includes a travel booking purchase, and, based on a positive determination, to further prompt travel booking data fetcher 104 to fetch 204 travel booking data associated with the transaction from the travel merchant system 114 via connection 152 (e.g., the internet). The advance-of-travel localized recommendation system 102 can determine that a transaction includes a travel booking purchase based, for example, on the identity of the merchant associated with the transaction, the categorization of the merchant, and/or the transaction price. For example, a purchase made from a merchant categorized as an airline exceeding a certain price threshold may be determined to be a likely flight booking purchase.

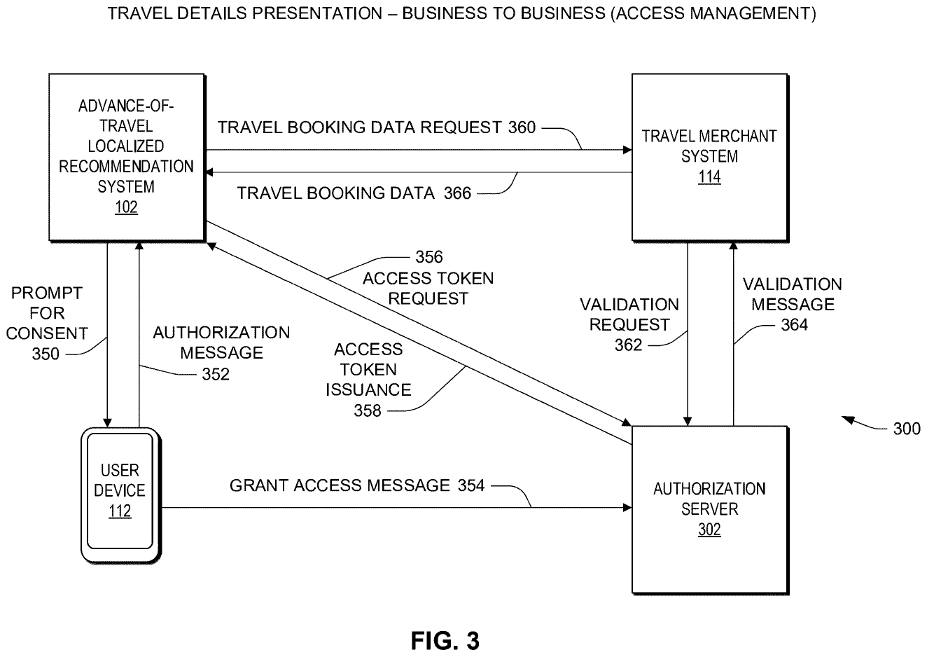

In some examples, travel booking data fetching can be facilitated by an API provided by an organization in custody or control of the travel merchant system 114. The travel booking data fetcher 104 can, for example, use the travel merchant system API to access the travel merchant system 114 and fetch the travel booking data from the travel merchant system 114. In some examples, this detailed travel booking data fetching 204 may have as a prerequisite a user authorization, an example of which, involving a separate authorization server not illustrated in FIG. 1, is described below with regard to FIG. 3. Having fetched 204 the detailed travel booking data, the travel booking data fetcher 104 can proceed to extract relevant data from the fetched data, including, as examples, the names or other identifying information of the traveler(s), date(s) and time(s) of travel, and travel destination(s). The other information that can identify the traveler(s) can include identification numbers (e.g., a travel document identification number, such as a driver's license number or other state identification number, or a passport number), financial account numbers (e.g., a credit card number or rewards program account number), birthdates, and any other identifying information that may be used in lieu of a name to identify one or more travelers, or to disambiguate between persons of same or similar names. The travel booking data fetcher 104 can then store the extracted relevant data to the travel booking details database 106. Travel booking details database 106 may be a data lake, data silo, semi-structured data system (CSV, logs, XML, etc.), unstructured data system, binary data repository, or other suitable repository.

In some examples, travel booking data fetcher 104 can be configured to automatically repeatedly (e.g., periodically) update travel booking data, for example, by repeated queries of a travel merchant system via B2B connection 152, or (not illustrated in FIG. 1) by repeated queries to a travel carrier system, such as an airline data system that can provide up-to-the-minute updated flight information. In this way, trip reschedulings and delays can be accounted for by advance-of-travel localized recommendation system 102, and travel dates and times can be repeatedly refined without additional user provision of information. Communication between the travel booking data fetcher 104 and a travel carrier system can be facilitated by an API provided by an organization in custody or control of the travel carrier system.

In some examples, the travel merchant system 114 and the advance-of-travel localized recommendation system in environment 100 may be in the custody or control of the same organization. In such examples, the operation of environment 100 may be simplified. For example, the travel merchant system 114 may be configured to automatically push detailed travel booking data to the travel booking data fetcher 104, without involving advance-of-travel localized recommendation system 102 in a determination that a transaction event 202 from the transaction processor 116 pertains to a travel booking purchase. In some examples, irrespective or ownership of the travel merchant system 114, the travel merchant system 114 may be configured to automatically push detailed travel booking data to the travel booking data fetcher 104, or to share detailed travel booking data for new bookings upon request from the travel booking data fetcher 104. Such examples have the advantage of providing detailed travel booking data to the travel transaction booking data fetcher 104 even in cases where the travel booking purchase does not involve the transaction processor 116, as may be the case when a travel booking is paid for in cash, using travel rewards points, or using some other payment method that does not involve the transaction processor 116.

In some examples, the advance-of-travel localized recommendation system 102 can protect the privacy of sensitive user travel information by prompting a user to grant consent for the advance-of-travel localized recommendation system 102 to access the detailed travel booking data (e.g., information identifying traveler(s), date(s), time(s), and destination(s) of travel). FIG. 3 illustrates the user authorization process with arrangement 300, which, in addition to the user device 112, the advance-of-travel localized recommendation system 102, and the travel merchant system 114 of FIG. 1, further includes an authorization server 302. The authorization server 302 and the other element 102, 112, 114 shown in FIG. 3 can be configured to function according to an authorization protocol, such as an OAuth authorization protocol (e.g., OAuth 2.0 or OAuth 2.1).

In the example of FIG. 3, a user device 112 of a purchaser associated with travel transaction data is presented a prompt to consent to data sharing of detailed travel booking data. The consent prompt can explain, for example, that travel booking data will be shared from the travel merchant system 114 to the organization in custody or control of the advance-of-travel localized recommendation system 102. The consent prompt can include, for example, a “consent” or “connect” button as part of a graphical user interface. As one example, the consent prompt can be in a mobile device app running on the user device 112. The mobile device app can be one provided by the organization in custody or control of the advance-of-travel localized recommendation system 102, or can be a third-party authorization app, for example, one provided by an organization in custody or control of the authorization server 302. As another example, the prompt can be in an email or text message, and can include a hyperlink that the user may follow to grant the travel data sharing consent. For example, advance-of-travel localized recommendation system 102 can trigger 350 the consent prompt to appear to the user device 112 in response to the receipt of the transaction event message 202 shown in FIG. 2.

Responsive to a user indicating the granting of travel data sharing consent via the user device 112, the user device 112 authorizes the travel data sharing by sending 352 an authorization message to the advance-of-travel localized recommendation system 102 and by sending 354 a grant access message to the authorization server 354. The advance-of-travel localized recommendation system 102 then sends 356 an authorization request to the authorization server 302. The authorization request can include a client identification number and a client secret to the authorization server 302 as identification. The authorization request is a request to receive an access token from the authorization server 302. The advance-of-travel localized recommendation system 102 can provide an endpoint Uniform Resource Identifier (URI), also known as a redirect URI, for the authorization server to use to send the access token. An example template of a portion of the redirect URI is /oauth2/authorize?client_id={CLIENT-ID}&redirect_uri={REDIRECT-URI}&response_type=code&state={STATE}.

In response to the authorization server 302 receiving the access token request 356 from the advance-of-travel localized recommendation system 102 and receiving the grant access message 354 from the user device 112, the authorization server 302 authenticates the access token request 356 of the advance-of-travel localized recommendation system 102. For example, the authorization server 302 can authenticate the access token request 356 of the advance-of-travel localized recommendation system 102 using the client identification number and a client secret. After authenticating the advance-of-travel localized recommendation system 102, the authorization server issues 358 the requested access token to the advance-of-travel localized recommendation system 102.

In response to receiving the access token from the authorization server 302, the advance-of-travel localized recommendation system 102 makes a travel data request 360 to the travel merchant system 114. For example, the travel booking data fetcher 104, shown in FIG. 1, may make the travel data request 360. The travel data request 360 includes the access token. The travel merchant system submits 362 a message requesting validation of the access token. In response to this message 362, the authorization server 302 replies 364 with a message validating the access token. In response to receiving the message 364 validating the access token, the travel merchant system 114 sends the requested travel data to the advance-of-travel localized recommendation system, which then receives 366 the requested travel data from the travel merchant system 114. For example, the travel booking data fetcher 104, shown in FIG. 1, may receive 360 the requested travel data.

In some examples, the process diagrammed in FIG. 3 may include more interactions or fewer interactions than shown. As one example, the access token request and issuance 356, 358 may involve a number of additional communications back and forth between the advance-of-travel localized recommendation system 102 and the authorization server 302 to negotiate and complete the authentication of the recommendation system 102 to the authorization server 302 and the access token issuance. As another example, the travel data request and receipt 360, 366 may involve a number of additional communications back and forth between the advance-of-travel localized recommendation system 102 and the travel merchant system 114 to negotiate and complete the travel data request fulfillment. As yet another example, the request validation 362, 364 may involve a number of additional communications back and forth between the travel merchant system 114 and the authorization server 302 to negotiate and complete the request validation.

FIG. 3 illustrates a consent method that relies on consent communicated from a user device 112 of a purchaser associated with a travel booking purchase transaction to authorize the fetching of detailed travel booking data from a travel merchant system 114. Subsequent to the fetching of the detailed travel booking data, it may be determined from the detailed travel booking data that one or more travelers identified in the detailed travel booking data is a person other than the purchaser. One or more separate consent authorization processes may subsequently be performed to obtain consent(s), from the individual traveler or travelers other than the purchaser, to send recommendation information to the traveler or travelers other than the purchaser. As one example, the fetched travel booking data may contain identifying information about a non-purchaser traveler, and the advance-of-travel localized recommendation system 102 may determine that this non-purchaser traveler already has an account with the organization in custody or control of the advance-of-travel localized recommendation system 102, such that an electronic address of a user device 112 of the non-purchaser traveler (e.g., a mobile phone number, an e-mail address, or an address at which mobile device application notifications or direct messages may be sent) is known to the organization in custody or control of the advance-of-travel localized recommendation system 102, or the travel booking data fetcher may, in some examples extract an electronic address of the non-purchaser traveler from the detailed travel booking data. The electronic address of the non-purchaser traveler identified in the detailed travel booking data can be sent to the advance-of-travel localized recommendation system 102, and the advance-of-travel localized recommendation system 102 can transmit a consent request message to a user device 112 of the non-purchaser travel, using the electronic address, requesting the non-purchaser traveler to consent to receiving travel recommendation information. The non-purchaser traveler can respond in an appropriate way (e.g., clicking a hyperlink in an email or text message, or clicking a consent button in a user interface of a mobile device application) to grant the consent, sending a consent message that is received by the advance-of-travel localized recommendation system 102 (e.g., via connection 154).

As another example, the advance-of-travel localized recommendation system 102 may determine that a non-purchaser traveler does not already have an account with the organization in custody or control of the advance-of-travel localized recommendation system 102, such that an electronic address of a user device 112 of the non-purchaser traveler is unknown to the organization in custody or control of the advance-of-travel localized recommendation system 102, and that an electronic address of the non-purchaser traveler cannot be extracted from the detailed travel booking data. Based on this determination, the advance-of-travel localized recommendation system 102 can send a message to the user device 112 of the purchaser requesting an electronic address for each of the one or more non-purchaser travelers. Upon the advance-of-travel localized recommendation system 102 receiving an electronic address for a non-purchaser traveler, the advance-of-travel localized recommendation system 102 can transmit a consent request message to a user device 112 of the non-purchaser travel requesting the non-purchaser traveler to consent to receiving travel recommendation information. The non-purchaser traveler can respond in an appropriate way to grant the consent, sending a consent message that is received by the advance-of-travel localized recommendation system 102.

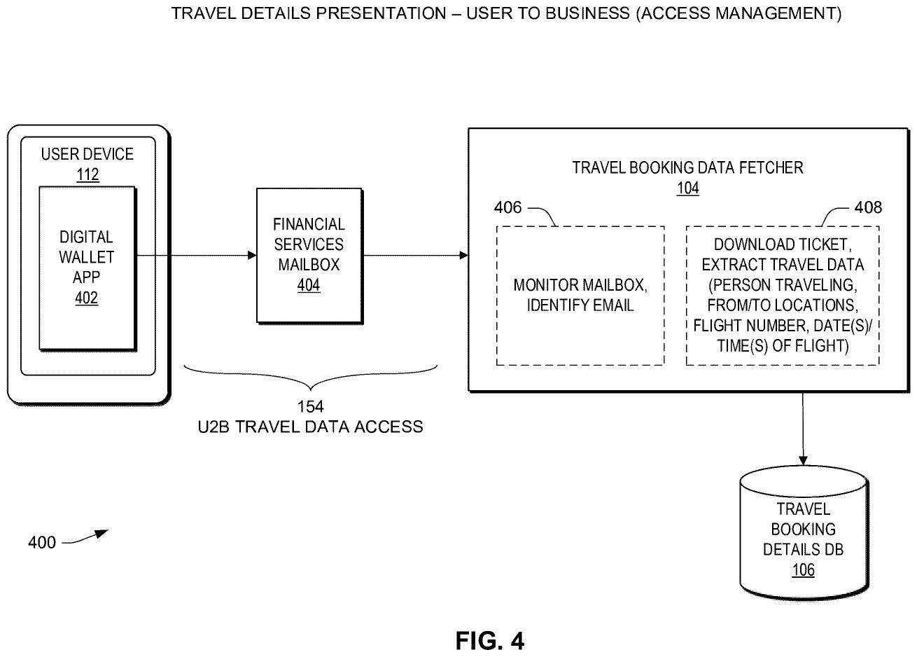

FIGS. 2 and 3 illustrate example B2B travel data access management processes. In other examples, a user may send a message containing detailed travel booking data to the advance-of-travel localized recommendation system 102, either directly or via another system that may provide the travel data to the advance-of-travel localized recommendation system 102. FIG. 4 illustrates a U2B access management process with arrangement 400 including the user device 112 and the travel booking data fetcher 104 of FIG. 1, and the U2B travel data access connection 154 between them. As an example, the U2B travel data access connection 154 can include a financial services mailbox 404 that serves as an intermediary between the user device 112 and the travel booking data fetcher 104. A digital wallet app 402 can run on the user device 112 and can securely store travel documents (e.g., travel tickets, boarding passes, travel booking confirmations, travel itineraries, travel booking sales receipts, or other documents that can contain detailed travel booking data such as information identifying traveler(s), travel date(s), travel time(s), and travel destination(s)). A user can use a graphical user interface of the digital wallet app 402 to send travel documents to the financial services mailbox 404 via email. The travel booking data fetcher 104 of the advance-of-travel localized recommendation system 102 can monitor 406 the financial services mailbox 406 and identify an email message containing one or more travel documents (e.g., an airline ticket). The travel booking data fetcher 104 can then download 408 the ticket from the financial services mailbox 404 and extract the detailed travel booking data (e.g., information identifying traveler(s), travel date(s), travel time(s), and travel destination(s)) from the travel document(s). The travel booking data fetcher 104 can then store the extracted detailed travel booking data in the travel booking details database 106 of the advance-of-travel localized recommendation system 102.

FIG. 5 illustrates an example arrangement 500 for training the advance-of-travel recommendation ML model 108 of the advance-of-travel localized recommendation system 102. The advance-of-travel recommendation ML model 108 can include one or more ML models and associated software routines (e.g., ML algorithms) used to train the one or more ML models. As one example, the advance-of-travel recommendation ML model can include a user spending priorities model that is trained using data pertaining to historical user interactions, preferences, and purchase behavior to understand individual user spending preferences. As another example, the advance-of-travel recommendation ML model can include an arbitration model that can be trained, for example, using data indicative of past accepted recommendations and/or timing data. After having been trained, during inferencing, the one or more ML models of the advance-of-travel recommendation ML model 108 can be provided one or more current user locations and/or estimated or predicted future user locations to output localized travel recommendations. In some examples, the one or more ML models can further be provided user profile data and/or purchase transaction history data as inputs to output localized travel recommendations. The user profile data and/or purchase transaction history data can be associated with the traveler for whom the recommendation is being generated, and/or can be associated with other persons. The current user location or estimated or predicted future user location can be based on travel date and time information acquired from the user via U2B travel data access, and/or acquired from the travel merchant system 114 via B2B travel data access, and/or real-time location data reported from user device 112.

For example, during inferencing to predict likely future user spending activities, the user spending priorities model can be provided as inputs a number of spending options (e.g., from recommendations database 126 and/or merchant dictionary and categorization database 120) and user profile information (e.g., from user profile information database 122) and can output one or more recommendations. For example, during inferencing to predict likely future user spending activities, the arbitration model can be provided as inputs a plurality of recommendations (e.g., as output from the user spending priorities model) and can output one or more recommendations, e.g., as a ranked list and/or as a time-staggered schedule of recommendations. In this way, a limited number of recommendations can be presented to a user (traveler) within a timeframe, so as not to overwhelm the user with a multiplicity of recommendations, and thus making recommendations potentially more receptively considered by the user.

The generated travel recommendations can correspond to suggested travel locations associated with the one or more travel destinations determined from the detailed travel booking data, such as individual merchants. For example, if a travel destination is a particular city, the recommendations can correspond to sights or merchants within the city or within a region surrounding the city. In some examples, the travel recommendations can correspond to particular offerings from individual merchants, such as one or more particular hotel room packages, one or more particular menu items, one or more particular event or show tickets, or one or more particular product or merchandise offerings. As an example, in a dining category, factors that can go into forming a travel recommendation can include cuisine choices (Mexican, Korean, hamburger, pizza, sandwich), type of dining (fine dining, fast food, etc.), per-meal expense range (e.g., in dollars, or symbolized as a number of dollar signs), preferred timing (e.g., breakfast, lunch, dinner, or late-night dining). As another example, in a shopping category, factors that can go into forming a travel recommendation can include shopping preferences, type of merchants, and expense range.

The advance-of-travel recommendation ML model 108 can receive past transaction data from transactions database 118 via connection 156. As an example, the past transaction data may include transaction data for individual transactions associating purchasers with merchants and amounts purchased. The advance-of-travel recommendation ML model 108 can also receive information about merchants and transaction categories from the merchant dictionary and categorization database 120 via connection 158. The merchant dictionary and categorization database 120 may store such useful parameters as a type of merchant for each merchant (categorizing each merchant), merchant reviews (e.g., crowdsourced from merchant review websites), and merchant locations (e.g., by address, GPS coordinates, or general neighborhood or region). Usefully, the merchant dictionary and categorization database 120 can include recommendations on locations frequented by local people at the travel destination. For example, recommendations database 126 can be at least in part created by consuming and processing online reviews of locations, such as from Yelp, Google Reviews, TripAdvisor, Facebook Recommendations, Angi, Zomato, OpenTable, Trustpilot, Foursquare, Better Business Bureau, Nextdoor, and/or similar local review providers, to derive information indicative of what businesses and activities the locals frequent or participate in. As one example, reviews that indicate, explicitly or implicitly, that they were written by the locals can be weighted more heavily than reviews that do not so indicate, when processed by the advance-of-travel recommendation ML model 108. As another example, consumed reviews can be pre-processed prior to storage in the merchant dictionary and categorization database and a separate data field can be used to flag reviews written by locals in the merchant dictionary and categorization database 120, and subsequently, the advance-of-travel recommendation ML model 108 can take this separate data field into account when generating personalized recommendations. The merchant dictionary and categorization database 120 may be a data lake, data silo, semi-structured data system (CSV, logs, XML, etc.), unstructured data system, binary data repository, or other suitable repository. The advance-of-travel recommendation ML model 108 can label and aggregate 502 transactions from the received transaction data based on data from the merchant dictionary and categorization database 120.

The advance-of-travel recommendation ML model 108 can also receive user profile information from user profile information database 122 via connection 160. As an example, the user profile information includes information about individual users, which can be derived from a variety of sources, including transactions database, voluntarily provided information, information sourced from third parties, and information sourced from the internet, such as social media accounts. The user profile information database 122 may store such demographic parameters as age, location (e.g., country, state, and/or city of residence, e.g., residential address), gender, and relationship (e.g., whether a user is single, in a relationship, married, and/or number of children). User profile information database 122 may be a data lake, data silo, semi-structured data system (CSV, logs, XML, etc.), unstructured data system, binary data repository, or other suitable repository. The ML model 108 can prepare 504 data based on the user profile information from the user profile information database 122.

Based on the prepared data, the advance-of-travel recommendation ML model 108 can generate 506 the spending priorities model, or improve an already-generated spending priorities model, using ML training. After having been trained, the spending priorities model can output travel recommendations based on, as inputs to the spending priorities model, user profile information for a user and a reported present user location or a predicted or estimated future user location. Also based on the prepared data, the advance-of-travel recommendation ML model 108 can generate 506 the arbitration model, or improve an already-generated arbitration model, using ML training. After having been training, the arbitration model can output travel recommendations that can, for example, be of the form of a ranked list of travel recommendations.

Advance-of-travel recommendation ML model 108 can be configured to generate its one or more ML models using ML training techniques. As an example, advance-of-travel recommendation ML model 108 can be configured to (i) define a neural network architecture (model), including a number of neurons arranged in a number of layers, each neuron having one or more inputs, one or more outputs, an activation function defining one or more output values based on values of the one or more inputs, and initialized weights; (ii) transfer training data to inputs of the neural network model; (iii) train the model incrementally based on the training data, e.g., by passing the training data and corresponding neuron outputs through the model, computing a loss function, calculating gradients of the loss function with respect to the weights using backpropagation, adjusting the weights using an optimization algorithm, and repeating the forward and backward propagation for a number of epochs; (iv) periodically (e.g., after each epoch) evaluate the model using validation data to monitor performance and avoid overfitting, and adjust hyperparameters (e.g., learning rate, batch size) based on the evaluation; (v) apply the trained model to process newly-received input data, and (vi) continue to train or re-train the trained model upon receipt of new data as training data or with a predetermined periodicity. In some examples, the trained neural network model may specify a neural network by at least a neural network topology, a series of activation functions, and connection weights. For example, the topology of a neural network may include a configuration of nodes of the neural network and connections between such nodes. In some examples, the trained neural network model may also be specified to include other parameters, such as bias values/functions and/or aggregation functions. For example, an activation function of a node may be a step function, a sine function, a continuous or piecewise linear function, a sigmoid function, a hyperbolic tangent function, or another type of mathematical function that represents a threshold at which the node is activated. In some examples, the aggregation function may be a function that combines (e.g., as a sum or product) input signals to the node. In some examples, an output of the aggregation function may be used as input to the activation function. In some examples, the bias may be a constant value or function that may be used by the aggregation function and/or the activation function to make the node more or less likely to be activated. Such a neural network can be, for example, a recurrent neural network, a long short-term memory neural network, bi-directional neural network, multi time scale neural network, convolutional neural network, or other suitable type of neural network.

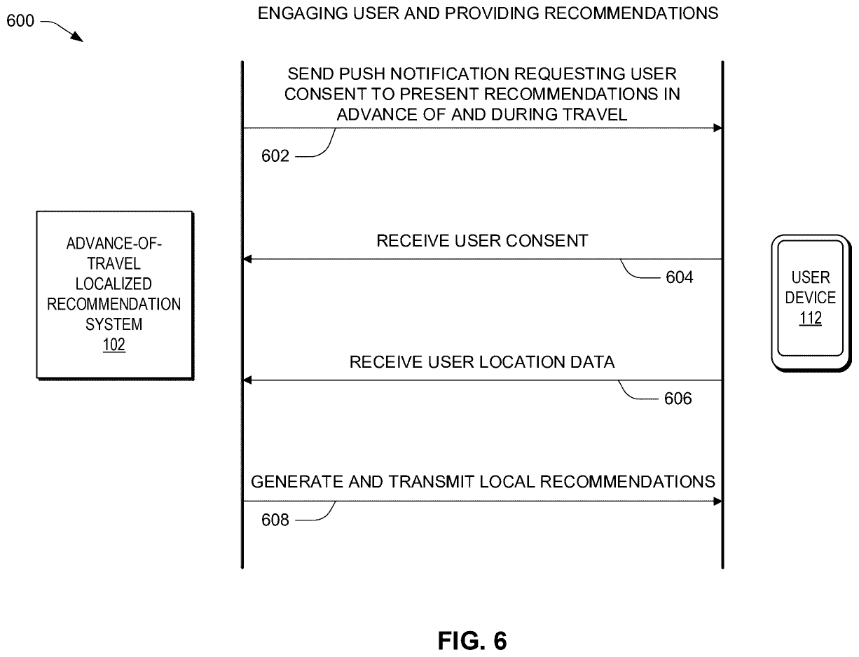

FIG. 6 illustrates the process of engaging a user and providing recommendations, as between an advance-of-travel localized recommendation system 102 and a user device 112. The advance-of-travel localized recommendation system 102 can send 602 a push notification to the user device 112 requesting user consent to present recommendations in advance of and during travel. In some examples, the consent-requesting push notification can be in response to receipt of the transaction event message 202 in FIG. 2. As an example, the consent can be granted as a single action with the granting of consent to share information, as part of the prompt for consent 350 in FIG. 3. In some examples, the advance-of-travel localized recommendation system 102 may determine, after the fetching of the detailed travel booking data, that the traveler is not the same as the user who made the booking purchase transaction. Such may be the case, for example, where one person buys a plane ticket for another person. Based on determining that one or more travelers is different from the purchaser, the advance-of-travel localized recommendation system 102 can request consent from non-purchaser travelers by sending 602 a push notification to any non-purchaser travelers requesting consent from non-purchaser travelers.

The advance-of-travel localized recommendation system 102 can subsequently receive 604 a message indicating consent from a user device 112 and can receive 606 real-time user location data. The real-time location data can be sent via connection 164 in FIG. 1. For example, the received user location data can comprise GPS coordinate data, or cellular or internet communication data (e.g., internet protocol address data) from which a present location can be determined, estimated, or predicted. The advance-of-travel localized recommendation system 102 can then generate and transmit 608 local recommendations to the user device 112. The local recommendations can be generated 608, for example, as push notifications, email, social media advertising, mobile app notifications, and/or website banners. For example, content packager 124 in FIG. 1 can automatically generate multimedia content, such as graphical content, video content, audio content, audiovisual content, or game content that presents the recommendations in an appealing way. For example, content packager 124 can include one or more generative AI models that can be input raw recommendation data to output the presentation content transmitted 608 to the user device 112 in any of the various forms described above. For example, the content packager 124 can be configured to input into a generative AI model a natural-language textual prompt or coded instruction to generate a banner ad formatted for a website or a graphical image or video formatted for social media based on the recommendation output provided by the advance-of-travel recommendation generator 110. The generative AI model can be trained to understand the natural-language textual prompt or coded instruction and to generate appropriate graphical or video content corresponding to the recommendation and including information about the recommendation. The content packager 124 can also include with the packaged recommendation a link to a website or other resource that provides more information about the recommendation and/or automatically schedules (e.g., in a personal calendar application of the user) or books a reservation (e.g., with a booking system of a merchant associated with the recommendation) for the recommendation. The transmission 608 of packaged recommendations to the user device 112 thus may not be direct transmission but may be transmission to a third party, such as a website or social network, for presentation to the user device 112.

The advance-of-travel localized recommendation system 102 can use the user location data to identify merchants local to the user as the user travels. For example, the output of the advance-of-travel recommendation ML model 108 can be based on the location data used as an input to the model 108. The location data can include travel destination data received from a travel merchant system 114 using a B2B travel data access process, travel destination data received from a user device 112 using a U2B travel data access process, and/or real-time location data (e.g., GPS data) received from a user device 112.

In some examples, advance-of-travel localized recommendation system 102 can weight more heavily in its recommendation rankings (e.g., as generated by advance-of-travel recommendation ML model) business and locations frequently by locals of a travel destination. As described above, merchant dictionary and categorization database 120 can be configured to include information indicative that a business or location is one known to and preferred by locals. This information can be taken into account by advance-of-travel recommendation ML model 108, which can be configured to weight local-preferred businesses and locations in its ranked recommendation outputs and can thereby generate recommendations ultimately delivered to user device 112 as packaged content with travel recommendations 168 that permit a user to “do as the locals do” and thus to have a better travel experience that provides more memorable or more engaging site visits, meals, entertainment activities, etc.

In some examples, advance-of-travel localized recommendation system 102 can increase foot traffic to targeted locations. For example, desired foot traffic targets can be labeled in the recommendations database 126, and the advance-of-travel recommendation ML model 108 can be trained to prioritize so-labeled targets in output recommendations, and/or advance-of-travel recommendation generator 110 can perform such prioritization using one or more prioritization rulesets based on outputs of the advance-of-travel recommendation ML model 108. In some examples, advance-of-travel localized recommendation system 102 can enable dining or event reservations at recommended restaurants or events (e.g., shows, screenings) by single click. For example, a notification of a recommendation provided to a user device 112 by content packager 124 can include a hyperlink or user interface button which, when activated by a user, can transmit a reservation to a merchant to automatically make the reservation, e.g., via secure hypertext transfer protocol (HTTPS) or an API call to an API merchant. The reservation can include personal information of the traveler (e.g., name) known to the advance-of-travel localized recommendation system 102.

In some examples, advance-of-travel localized recommendation system 102 can use user engagement metrics to assess the effectiveness of location-based recommendations. For example, previously made recommendations can be determined as accepted or declined based on data from the transactions database 118 and these determinations can be integrated into the user profile data stored in the user profile information database 122. As one example, the user profile data stored in the user profile information database 122 can include recommendation acceptance/rejection history data for each given user. As another example, the user profile data stored in the user profile information database 122 can include one or more metrics derived from recommendation acceptance/rejection history data for each given user, which one or more metrics may distill the recommendation acceptance/rejection history data. The advance-of-travel recommendation ML model 108 can repeatedly (e.g., periodically) re-train on the updated user profile data stored in the user profile information database 122. The updated user profile data stored in the user profile information database 122 can also be analyzed for various metrics. The advance-of-travel localized recommendation system can thus understand, and/or can assist with understanding, which recommendations drive the most user interactions, conversions, and overall customer satisfaction.

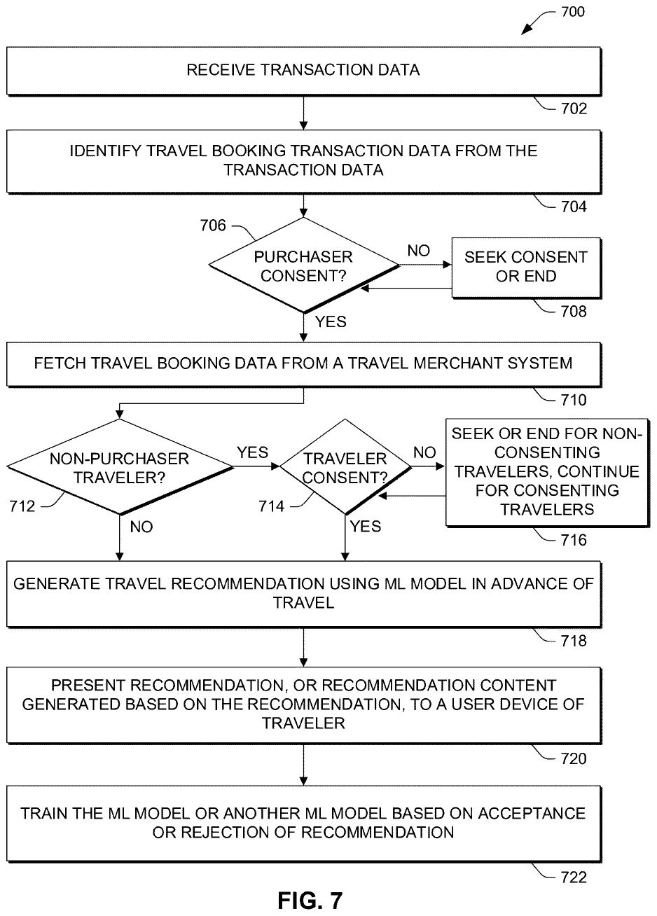

The flow diagram of FIG. 7 illustrates an example computer-implemented method 700 of advance-of-travel localized recommendations. An advance-of-travel localized recommendation system 102 can receive 702 transaction data indicative of a purchase. In some examples, the transaction data can be received from a transaction processor 116 that processes payments or can be fetched from a transactions database 118 to which the transaction processor 116 stores transaction data. In other examples, the advance-of-travel localized recommendation system 102 can fetch the transaction data from the transactions database 118, e.g., intermittently or periodically, to retrieve transaction data newly added to the transactions database 118 since the last fetch operation. The advance-of-travel localized recommendation system 102 can identify 704 booking transaction data from the received transaction data. The advance-of-travel localized recommendation system 102 can then determine 706 whether the purchaser (e.g., an individual associated with the purchase whose funds paid for the purchase) has provided consent for the advance-of-travel localized recommendation system 102 to fetch travel booking data from the travel merchant system. The provided consent can be on a per-transaction basis (e.g., with each new identification of a travel booking purchase, a new purchaser consent is requested before fetching 710 travel booking data from a travel merchant system) or can be on an ongoing basis associated with the purchaser (e.g., as part of a service agreement, such as a clickwrap agreement associated with usage of a website or a mobile device application). The determination 706 of purchaser consent can also include a determination of whether the purchaser has agreed to receive advance-of-travel recommendations. Based on determining 706 that the purchaser has not yet provided such consent, the consent can be sought 708, for example, with a method like that illustrated in FIG. 3. For example, the consent seeking 708 can include the advance-of-travel localized recommendation system 102 transmitting 350 a consent prompt message to a user device 112 of a purchaser associated with the travel booking transaction data prompting for consent from the purchaser, receiving 352 a consent message from the user device 112 of the purchaser in response to the consent prompt message, transmitting 356 an access token request message to an authorization server 302, and receiving 358 an access token issuance message including an access token from the authorization server 302. Based on not receiving purchaser consent, the method 700 can end 708.

Based on receiving purchaser consent, the method 700 can proceed to the advance-of-travel localized recommendation system 102 (e.g., its travel booking data fetcher 104) fetching 710 travel booking data associated with the travel booking transaction data from the travel merchant system 114. The travel booking data fetching 710 can proceed as illustrated in FIG. 2, for example. For example, the fetching 710 of method 700 can include, as illustrated in FIG. 3, transmitting 360 a travel booking data request message including the access token to the travel merchant system 114 and receiving 366 the travel booking data from the travel merchant system 114 based on the travel merchant system 114 validating 362, 364 the access token with the authorization server 302. As illustrated in 206 in FIG. 2, the travel booking data can identify at least one traveler (in some examples, multiple travelers), at least one travel destination (in some examples, more than one travel destination), at least one date and time of travel (in some examples, more than one date and time of travel).

After having fetched 710 the travel booking data from the travel merchant system 114, and before presenting 720 recommendations to any non-purchaser travelers, the advance-of-travel localized recommendation system 102 can ensure it has consent to present 270 recommendations to travelers. For example, the advance-of-travel localized recommendation system 102 can determine 712, based on the received travel booking data, whether the at least one traveler, as identified in the travel booking data fetched from the travel merchant system, is a person other than the purchaser. For example, the advance-of-travel localized recommendation system 102 can compare an identifier (e.g., name or ID number) of the purchaser with an identifier of the at least one traveler. Based on the advance-of-travel localized recommendation system 102 determining 712 that the at least one traveler is a person other than the purchaser, the advance-of-travel localized recommendation system 102 can determine 714 whether the at least one (non-purchaser) traveler has consented to receive travel recommendations, and, based on the advance-of-travel localized recommendation system 102 determining 714 that the at least one (non-purchaser) traveler has not consented to receive travel recommendations, the advance-of-travel localized recommendation system 102 can seek 716 to receive consent from a user device 112 of the non-purchaser traveler, e.g., by transmitting a consent request prompt to a user device 112 of the non-purchaser traveler and receiving an affirmative response (consent message). As examples, the consent request can be sent by text message, mobile device app notification, or email. In some examples, the advance-of-travel localized recommendation system 102 will not present 720 travel recommendations to any non-consenting travelers, that is, to any travelers for whom a consent message has not been received, or who have not provided prior consent, e.g., as part of a service agreement or website or app usage agreement. The seeking 716 of consent can be repeated for any travelers who have not already consented to receive the recommendations.

The advance-of-travel localized recommendation system 102 can generate 718 a recommendation associated with the at least one travel destination based on the travel booking data. For example, the recommendation can be generated 718 using an ML model 108 trained on purchase transaction history data. For example, the ML model 108 can have been trained as described above with regard to FIG. 5. For example, the advance-of-travel localized recommendation system 102 can generate 718 the recommendation in advance of the at least one date and time of travel. Based on the advance-of-travel localized recommendation system 102 determining 706 purchaser consent to receive travel recommendations and (a) determining 712 that there are no non-purchaser travelers and/or (b) based on determining (receiving or previously having received) 714 consent from one or more non-purchaser travelers (that is, based on having received consent from at least one traveler), the advance-of-travel localized recommendation system 102 can present 720 the recommendation, or recommendation content generated based on the recommendation, to a user device 112 of the at least one traveler.

In some examples, the recommendation or the recommendation content can be queued in advance of the at least one date and time of travel for presentation 720 at the user device 112 of the at least one traveler at a queued time that is based on the at least one date and time of travel (e.g., at an evening time before a morning flight, or at a morning time before an evening flight, or at a time within a window before takeoff, at an estimated or expected time of a flight landing). As examples, the recommendation or recommendation content can be sent by a push notification, an email, a social media platform advertisement, a mobile device application notification, or a website banner.

As an example, the recommendation content presented 720 to the user device 112 of the at least one traveler, which can include the recommendation, can be generated by the content packager 124, based on the recommendation, by generating a natural-language textual prompt or a coded instruction based on the recommendation, providing the natural-language textual prompt or coded instruction to a generative artificial intelligence (generative AI) model, and generating the recommendation content as a picture, video, or game using the generative AI model. Example generative AI models include OpenAI GPT-4 or GPT-4o, Google Gemini 1.5 Pro, OpenAI DALLE-3, OpenAI Sora, Runway Gen-2, Midjourney, Stability AI Stable Diffusion, Adobe Firefly, and Getty Generative AI. These examples include text-to-video models, text-to-image models, text-to-text models, and text-to-code models. For example, a text-to-code model can interpret a natural-language textual prompt to generate script code or executable code, which can be run, for example, by a web browser or other user interface as an interactive game. As another example, a text-to-image or text-to-video model can interpret a natural-language textual prompt to generate a still image or video, which can be sent to an ad distribution system, website, or social media company to present as an advertisement banner or advertisement video targeted to be seen by the traveler upon visiting the corresponding website or social media network.

The advance-of-travel recommendation system 102 can track whether a presented 720 recommendation is accepted or rejected by its recipient. For example, the advance-of-travel recommendation system 102 may receive direct feedback from a UI used to present 720 the recommendation, such as when a traveler in receipt of a recommendation clicks on a hyperlink or activates an app control (e.g., button) to accept a purchase offer or to book a dining or entertainment reservation, as examples, or to expressly reject a recommendation. In some examples, the advance-of-travel recommendation system 102 may receive indirect feedback of acceptance of an offer by noting a correspondence between presentation of an offer and a subsequent purchase by the traveler as may be determined from a transaction event message 202 and/or data fetched from the transactions database 118. For example, the subsequent purchase may be made within a time window. The time window, for example, can be based on the known or estimated travel window as may be determined from the travel booking data fetched 710 from the travel merchant system 114. If no express rejection is made and no corresponding purchase made within the time window is evident from the traveler's transaction history, the advance-of-travel recommendation system 102 may assume that the recommendation was rejected. Information about presented recommendation acceptances and rejections can be stored in a database, such as the travel booking details database 106, the recommendations database 126, or another database in communication with the advance-of-travel localized recommendation system 102.

In some examples, the method 700 can continue by the advance-of-travel recommendation system 102 training 722 the ML model used to generate 718 an accepted or rejected travel recommendation, or another ML model, based on the acceptance or rejection of the recommendation. This training can provide a feedback loop within the advance-of-travel recommendation system 102, which can further learn traveler preferences and update its ML model 108, or another model, based on the rejection or acceptance of previously presented recommendations so as to improve the model's generation of recommendations in the future.

Not all steps may be needed to perform the disclosure provided herein. Further, some of the steps may be performed simultaneously, or in a different order than shown in FIG. 7. As one example, a recommendation may be generated 718 before obtaining 708, 716 consent from a corresponding traveler to present 720 the recommendation to the traveler.

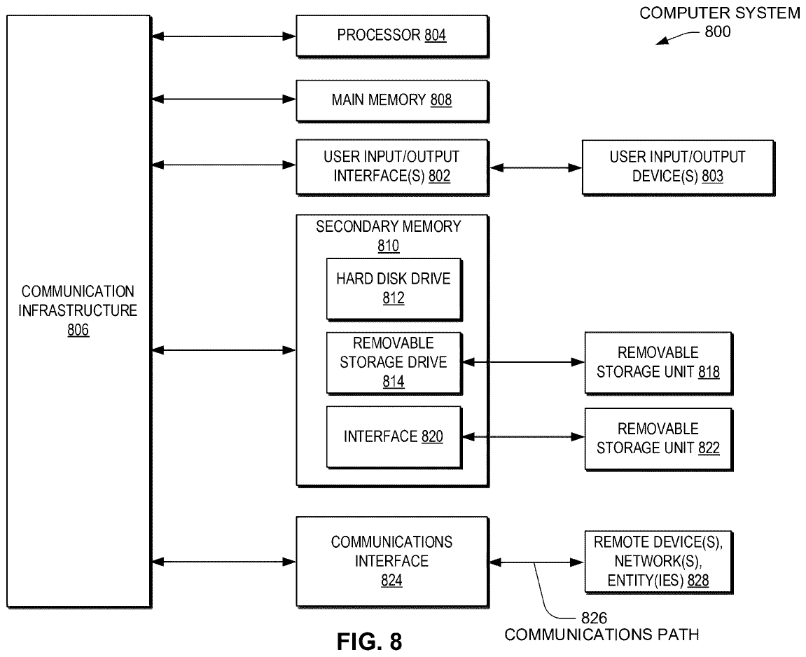

Various embodiments may be implemented, for example, using one or more well-known computer systems, such as computer system 800 shown in FIG. 8. One or more computer systems 800 may be used, for example, to implement any of the embodiments discussed herein, as well as combinations and sub-combinations thereof. One or more computer systems 800 may be used, for example, to implement the advance-of-travel recommendation system 102, the content packager 124, the user device 112, the transaction processor 116, and/or the travel merchant system 114.

Computer system 800 may include one or more processors (also called central processing units, or CPUs), such as a processor 804. Processor 804 may be connected to a communication infrastructure or bus 806.

Computer system 800 may also include user input/output device(s) 803, such as monitors, keyboards, pointing devices, etc., which may communicate with communication infrastructure 806 through user input/output interface(s) 802.

One or more of processors 804 may be a graphics processing unit (GPU), a tensor processing unit (TPU, or an AI processing unit (AIPU). In an embodiment, a GPU, TPU, or AIPU may be a processor that is a specialized electronic circuit designed to process mathematically intensive applications. The GPU, TPU, or AIPU may have a parallel structure that is efficient for parallel processing of large blocks of data, such as mathematically intensive data common to computer graphics or ML applications, images, videos, etc.

Computer system 800 may also include a main or primary memory 808, such as random access memory (RAM). Main memory 808 may include one or more levels of cache. Main memory 808 may have stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 may include a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 may read from and/or write to removable storage unit 818.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the internet of things (IoT), and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premises” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1. A computer-implemented method comprising:
receiving, by a computer processor, transaction data indicative of a purchase;
identifying, from the transaction data, travel booking transaction data indicative of a travel booking purchased using a travel merchant system;
fetching, from the travel merchant system, travel booking data associated with the travel booking transaction data, wherein the travel booking data identifies at least one traveler, at least one travel destination, at least one date and time of travel, wherein the fetching the travel booking data from the travel merchant system comprises:
transmitting a consent prompt message to a user device of a purchaser associated with the travel booking transaction data prompting for consent from the purchaser;
receiving a consent message from the user device of the purchaser in response to the consent prompt message;
transmitting an access token request message to an authorization server;
receiving an access token issuance message including an access token from the authorization server;
transmitting a travel booking data request message including the access token to the travel merchant system; and
receiving the travel booking data from the travel merchant system based on the travel merchant system validating the access token with the authorization server;
generating, in advance of the at least one date and time of travel, a recommendation associated with the at least one travel destination based on the travel booking data, using a machine-learning model trained on purchase transaction history data;
determining, based on the received travel booking data, that the at least one traveler is a person other than the purchaser;
transmitting a second consent prompt message to the user device of the at least one traveler prompting for consent from the at least one traveler;
receiving a second consent message from the user device of the at least one traveler; and
presenting, based on the receiving the second consent message, the recommendation or recommendation content generated based on the recommendation to a user device of the at least one traveler.

2-3. (canceled)

4. The method of claim 1, further comprising, after the generating the recommendation and before presenting the recommendation or the recommendation content:
queuing, in advance of the at least one date and time of travel, the recommendation or the recommendation content for the presentation to the user device of the at least one traveler at a queued time that is based on the at least one date and time of travel,
wherein the recommendation or the recommendation content is presented to the user device of the at least one traveler at the queued time.

5. The method of claim 1, wherein the recommendation content is presented to the user device of the at least one traveler, and wherein the recommendation content comprises one of a push notification, an email, a social media platform advertisement, a mobile device application notification, or a website banner.

6. The method of claim 1, wherein the recommendation content is presented to the user device of the at least one traveler, and wherein the method further comprises generating the recommendation content based on the recommendation, wherein the generating the recommendation content comprises:
generating a natural-language textual prompt or a coded instruction based on the recommendation;
providing the natural-language textual prompt or coded instruction to a generative artificial intelligence (generative AI) model; and
generating, using the generative AI model, the recommendation content as a picture, video, or game, wherein recommendation content includes the recommendation.

7. The method of claim 1, further comprising:
training the ML or another ML model based on acceptance or rejection of the presented recommendation or recommendation content.

8. A system comprising:
a memory; and
at least one processor coupled to the memory and configured to:
receive transaction data indicative of a purchase;
identify, from the transaction data, travel booking transaction data indicative of a travel booking purchased using a travel merchant system;
fetch, from the travel merchant system, travel booking data associated with the travel booking transaction data, wherein the travel booking data identifies at least one traveler, at least one travel destination, at least one date and time of travel, wherein the fetching the travel booking data from the travel merchant system comprises:
transmitting a consent prompt message to a user device of a purchaser associated with the travel booking transaction data prompting for consent from the purchaser;
receiving a consent message from the user device of the purchaser in response to the consent prompt message;
transmitting an access token request message to an authorization server;
receiving an access token issuance message including an access token from the authorization server;
transmitting a travel booking data request message including the access token to the travel merchant system; and
receiving the travel booking data from the travel merchant system based on the travel merchant system validating the access token with the authorization server;
generate, in advance of the at least one date and time of travel, a recommendation associated with the at least one travel destination based on the travel booking data, using a machine-learning model trained on purchase transaction history data;
determine, based on the received travel booking data, that the at least one traveler is a person other than the purchaser;
transmit a second consent prompt message to the user device of the at least one traveler prompting for consent from the at least one traveler;
receive a second consent message from the user device of the at least one traveler; and
present, based on the receiving the second consent message, the recommendation or recommendation content generated based on the recommendation to a user device of the at least one traveler.

9-10. (canceled)

11. The system of claim 8, wherein the at least one processor is further configured to, after the generating the recommendation and before presenting the recommendation or the recommendation content:
queue, in advance of the at least one date and time of travel, the recommendation or the recommendation content for the presentation to the user device of the at least one traveler at a queued time that is based on the at least one date and time of travel,
wherein the recommendation or the recommendation content is presented to the user device of the at least one traveler at the queued time.

12. The system of claim 8, wherein the recommendation content is presented to the user device of the at least one traveler, and wherein the recommendation content comprises one of a push notification, an email, a social media platform advertisement, a mobile device application notification, or a website banner.

13. The system of claim 8, wherein the recommendation content is presented to the user device of the at least one traveler, and wherein the method further comprises generating the recommendation content based on the recommendation, wherein the generating the recommendation content comprises:
generating a natural-language textual prompt or a coded instruction based on the recommendation;
providing the natural-language textual prompt or coded instruction to a generative artificial intelligence (generative AI) model; and
generating, using the generative AI model, the recommendation content as a picture, video, or game, wherein recommendation content includes the recommendation.

14. The system of claim 8, wherein the at least one processor is further configured to:
train the ML or another ML model based on acceptance or rejection of the presented recommendation or recommendation content.

15. A non-transitory computer-readable medium having instructions stored thereon that, when executed by at least one computing device, cause the at least one computing device to perform operations comprising:
receiving transaction data indicative of a purchase;
identifying, from the transaction data, travel booking transaction data indicative of a travel booking purchased using a travel merchant system;
fetching, from the travel merchant system, travel booking data associated with the travel booking transaction data, wherein the travel booking data identifies at least one traveler, at least one travel destination, at least one date and time of travel, wherein the fetching the travel booking data from the travel merchant system comprises:
transmitting a consent prompt message to a user device of a purchaser associated with the travel booking transaction data prompting for consent from the purchaser;
receiving a consent message from the user device of the purchaser in response to the consent prompt message;
transmitting an access token request message to an authorization server;
receiving an access token issuance message including an access token from the authorization server;
transmitting a travel booking data request message including the access token to the travel merchant system; and
receiving the travel booking data from the travel merchant system based on the travel merchant system validating the access token with the authorization server;
generating, in advance of the at least one date and time of travel, a recommendation associated with the at least one travel destination based on the travel booking data, using a machine-learning model trained on purchase transaction history data;
determining, based on the received travel booking data, that the at least one traveler is a person other than the purchaser;
transmitting a second consent prompt message to the user device of the at least one traveler prompting for consent from the at least one traveler;
receiving a second consent message from the user device of the at least one traveler; and
presenting, based on the receiving the second consent message, the recommendation or recommendation content generated based on the recommendation to a user device of the at least one traveler.

16-17. (canceled)

18. The non-transitory computer-readable medium of claim 15, the operations further comprising, after the generating the recommendation and before presenting the recommendation or the recommendation content:
queuing, in advance of the at least one date and time of travel, the recommendation or the recommendation content for the presentation to the user device of the at least one traveler at a queued time that is based on the at least one date and time of travel,
wherein the recommendation or the recommendation content is presented to the user device of the at least one traveler at the queued time.

19. The non-transitory computer-readable medium of claim 15, wherein the recommendation content is presented to the user device of the at least one traveler, the operations further comprising generating the recommendation content based on the recommendation, wherein the generating the recommendation content comprises:
generating a natural-language textual prompt or a coded instruction based on the recommendation;
providing the natural-language textual prompt or coded instruction to a generative artificial intelligence (generative AI) model; and
generating, using the generative AI model, the recommendation content as a picture, video, or game, wherein recommendation content includes the recommendation.

20. The non-transitory computer-readable medium of claim 15, the operations further comprising:
training the ML or another ML model based on acceptance or rejection of the presented recommendation or recommendation content.
